(19) United States
(12) Patent Application Publication
(10) Pub. No.: US 2002/0071751 A1
(43) Pub. Date: Jun. 13, 2002

(54) Apparatus for lifting and transporting heavy objects

(76) Inventors: Robert R. Brice, Coral Springs, FL (US); Lee Mason, Coral Springs, FL (US)

Correspondence Address: Mark D. Bowen, Stearns Weaver Miller, et al., 200 East Broward Boulevard, Suite 1900, Fort Lauderdale, FL, 33301, US

(21) Appl. No.: 10/010,424

(22) Filed: Dec. 7, 2001

Related U.S. Application Data
(60) Provisional application No. 60/254,054, filed on Dec. 7, 2000.

(51) Int. Cl. B60P 3/00

(52) U.S. Cl. 414/458

(57) ABSTRACT

An apparatus for lifting and transporting heavy loads enables a single user to lift a heavy object, such as a safe or strong box, and move the object thereby assisting in delivery, installation and maintenance. Adjustable features enable reconfiguration of the apparatus to handle loads of varying dimensions. A frame-type structure, having an upper assembly supported by four downwardly depending legs, is supported by wheels. Each of the downwardly depending legs is comprised of at least two telescopically adjustable members and a leg adjusting mechanism which cooperate for simultaneously effecting axial extension and retraction of the four legs utilizing the benefits of mechanical advantage. A plurality of telescopically adjustable, downwardly projecting load-engaging members is supported by the upper assembly in a configuration that allows for spacing adjustment. The apparatus is may be specifically adapted for loading and unloading objects from the bed of a motorized vehicle, such as a flat bed truck or van. A pair of rails may be deployed to form a bridge from the cargo bed of a delivery truck to the lifting apparatus such that a safe riding on a dolly may be loaded thereon.

### CROSS-REFERENCE TO RELATED APPLICATIONS

This application claims the benefit of U.S. provisional application Serial No. 60/254,054, filed Dec. 7, 2000.

### STATEMENT REGARDING FEDERALLY SPONSORED RESEARCH OR DEVELOPMENT

N/A

### BACKGROUND OF THE INVENTION

1. Field of the Invention

This invention relates to mechanical apparatus for lifting and transporting heavy objects, and more particularly to an apparatus for lifting and transporting heavy objects such as strong boxes, safes, and other bulky or massive objects.

2. Description of Related Art

The use of mechanical apparatus to assist in situations requiring the lifting and transport of large and heavy objects may be traced to earliest discovery of leverage principles, and the application of said principles to gain various mechanical advantages. Accordingly, a number of machines dedicated to the lifting and/or moving of various heavy objects are known in the art. For example, U.S. Pat. No. 2,982,430, issued to Clifton, discloses a straddle-type load-carrying vehicle having a hydraulically operated hoist mechanism powered by an internal combustion engine. U.S. Pat. No. 3,161,309, issued to Baudhuin et al., discloses a load handling apparatus comprising a grapple mechanism for use on a mobile lift for handling large articles. U.S. Pat. No. 3,251,496, issued to Lamer et al., discloses a load handling apparatus comprising a vehicle and grapple mechanism for lifting and transporting cargo carriers, such as large containers, trailers, and the like. U.S. Pat. No. 3,768,676, issued to Spitzer, discloses a load straddling, lifting, handling and transporting device which enables a single user to clampingly harness a heavy office desk, or the like, and move same from a room to facilitate cleaning. U.S. Pat. Nos. 4,227,464 and 4,334,480, each issued to Wallace, disclose leg structures for portable, height-adjustable gantries having an upper, single vertical tubular post member telescopically received within an open-ended sleeve formed by coupled aligned channel members of lower, break-apart section supporting framework. U.S. Pat. No. 4,491,452 issued to Matovich, discloses a load lifting and transporting apparatus wherein a plurality of individual units can be combined into a configuration corresponding to the configuration of the load. U.S. Pat. No. 4,897,011, issued to Brower, discloses a mechanical lifting device having a framework which may be collapsed or assembled and comprises a plurality of tubular pieces which are held in place by bolts utilized as set screws. U.S. Pat. No. 5,397,207, issued to Arellano et al, discloses an adjustable ceiling panel installer which consists of a base frame member with a plurality of wheels mounted to the underside of the base frame member, so as to make the base frame member maneuverable.

The background art reveals the importance of lifting machines configured for specialized lifting applications. While the lifting machines of the background art may be adequate for their various intended purposes, those devices are limited to specific lifting applications. The background art fails to disclose a compact mechanical load lifting apparatus specifically configured to enable a user to lift and transport heavy objects, such as safes, on and off delivery vehicles and for delivery to and/or removal from a building.

### BRIEF SUMMARY OF THE INVENTION

The present invention provides a mechanical load lifting and transport apparatus which enables a single user to lift a heavy object, such as a safe or strong box, and move the object thereby assisting in the delivery, installation and maintenance of such objects. The load lifting apparatus includes adjustable features that enable reconfiguration of the apparatus to handle loads of varying dimensions. The apparatus includes a frame-type structure having an upper assembly supported by four downwardly depending legs, which legs each terminate in a wheeled assembly. Each of the four downwardly depending legs are comprised of at least two telescopically adjustable members and a leg adjusting mechanism which cooperate for simultaneously effecting axial extension and retraction of the four legs utilizing the benefits of mechanical advantage. The leg adjusting mechanism may be actuated by a hand crank, and is adapted for actuation by a hand-held drill or other tool. A plurality of telescopically adjustable, downwardly projecting load-engaging members, for supporting a load (e.g. safe), are supported by the upper assembly in a configuration that allows for spacing adjustment. The apparatus is may be specifically adapted for loading and unloading objects between the apparatus and the bed of a motorized vehicle, such as a flat bed truck or van. In a preferred embodiment a pair of rails may be generally horizontally positioned so as to form a bridge from the cargo bed of a delivery truck to the lifting apparatus such that a safe riding on a dolly may be rolled to or from the lifting apparatus.

Accordingly, it is an object of the present invention to provide an improved apparatus for lifting and transporting heavy objects such as strong boxes and safes.

Still another object of the present invention is to provide a load lifting apparatus that enables a single user to lift and transport heavy objects.

Yet another object of the present invention is to provide an apparatus for lifting and transporting safes that includes rails for loading and unloading the safe from the bed of a truck or van.

In accordance with these and other objects that will become apparent hereinafter, the instant invention will now be described with particular reference to the accompanying drawings.

### BRIEF DESCRIPTION OF THE SEVERAL VIEWS OF THE DRAWINGS

FIG. 1 is a front view, in partial section, of an apparatus according to the present invention;

FIG. 2 is a perspective view of an apparatus according to the present invention;

FIG. 3 is a partial detail view depicting a portion of the vertical adjusting mechanism;

FIG. 4 is a perspective view depicting the apparatus supporting a safe; and

FIG. 5 is a side view depicting the apparatus in use while loading a safe from a truck.

### DETAILED DESCRIPTION OF THE INVENTION

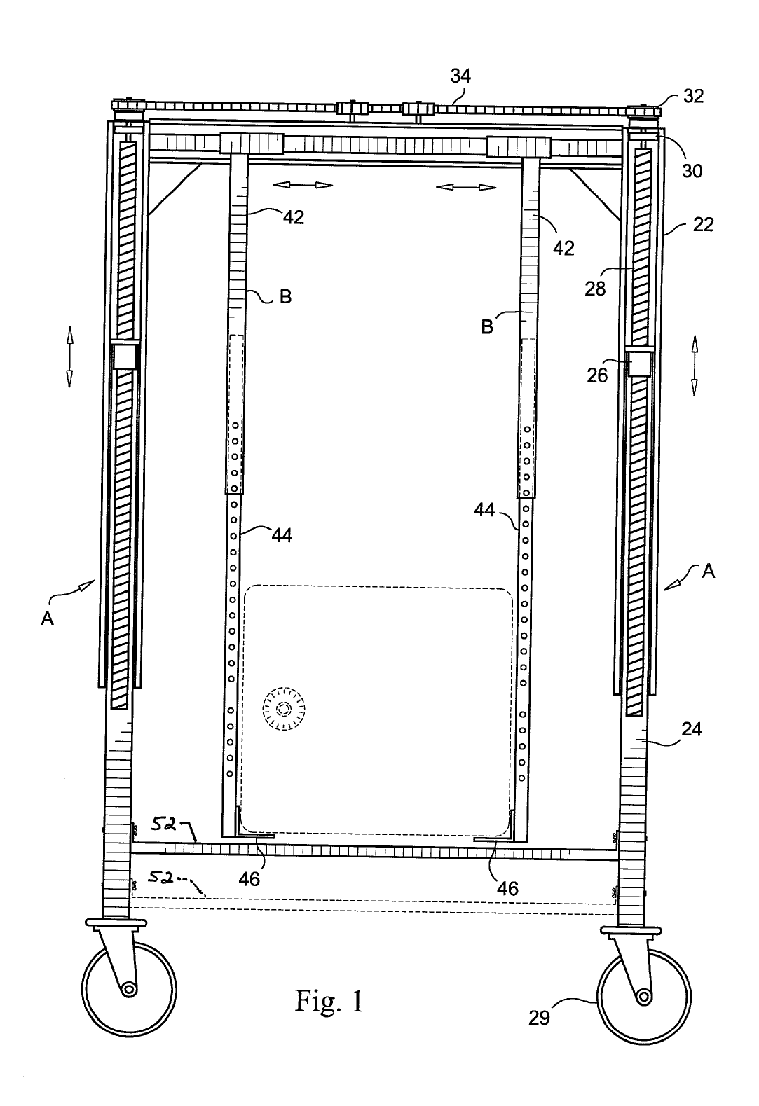

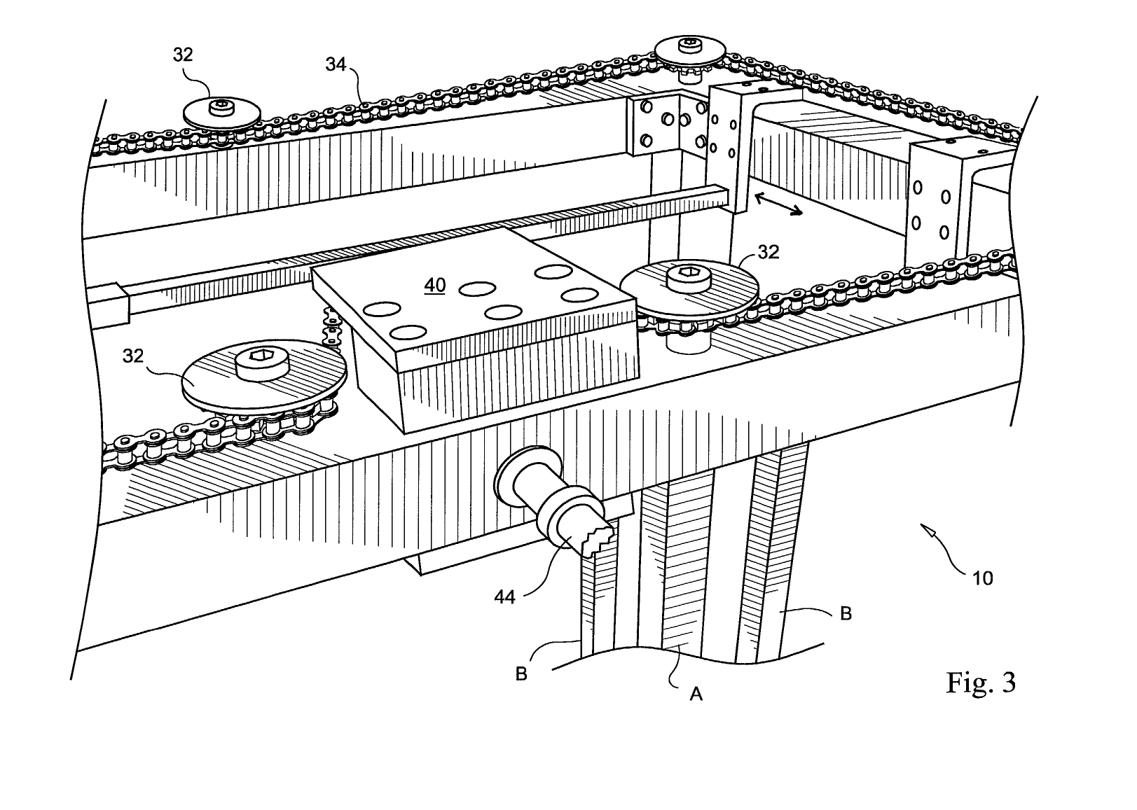

With reference now to the drawings, FIGS. 1-5 depict a preferred embodiment of the present invention. The invention provides a mechanical apparatus, generally referenced as 10, for lifting and transporting loads. Apparatus 10 enables a single person to lift a heavy object, such as a safe or strong box, and move the object thereby assisting in the delivery, installation and maintenance of safes and strong boxes. The apparatus includes a frame-type structure having an upper assembly supported by four downwardly extending legs, each of which is referenced as “A”. The upper assembly further supports four downwardly projecting, load-engaging members, each of which is referenced as “B”. Load-engaging members “B” are each slidably adjustable so allow for positioning the members for loads of various dimensions.

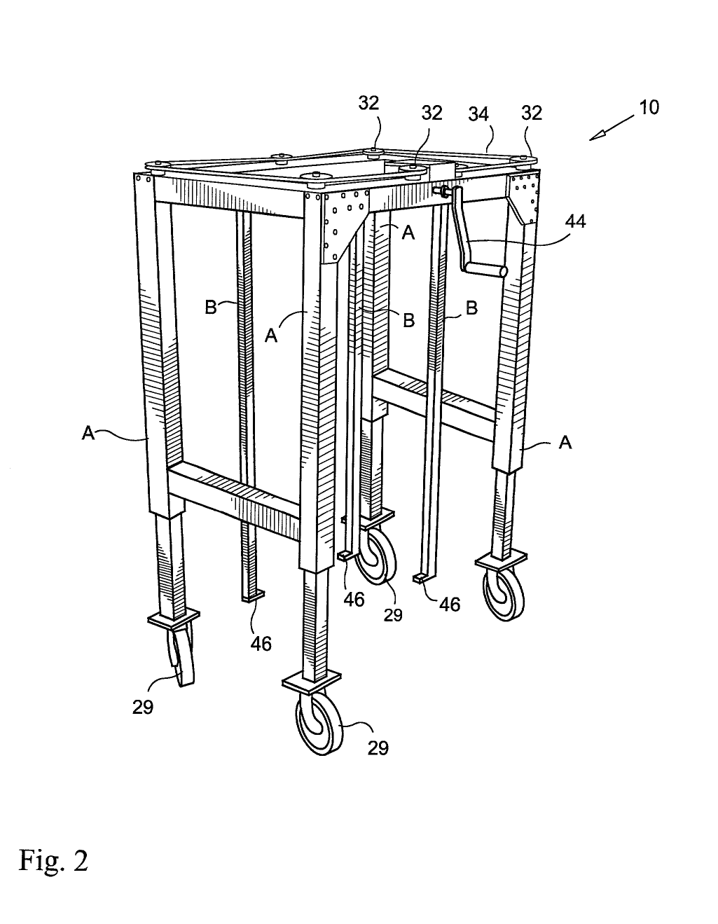

As best seen in FIGS. 1-5, each leg “A” includes at least two telescopically adjustable rigid members including an upper leg member 22 and a lower leg member 24 in extendable and retractable telescopic engagement therewith. Each leg “A” further includes an internally threaded member 26 fixed to the upper end of lower leg member 24. Threaded member 26 defines an internally threaded opening extending completely therethrough and receives a threaded jackscrew 28, which has external threads meshed with the internal threads defined by member 26 such that rotation of the jackscrew causes the jackscrew, and fixedly attached upper leg member 22, to move axially relative to sleeve 26 and inner member 24. A portion of the jackscrew extends to the upper portion of upper leg member 22 where a bearing 30 is mounted to allow for rotation of the jackscrew. Each jackscrew has a gear 32 affixed at the top thereof. A chain 34 is installed around and meshed with each gear 32 and is further connected to a crank mechanism 40. Crank mechanism 40 may be actuated by a hand crank, referenced as 44, shown in an operative position in FIG. 2. Crank mechanism 40 is also preferably adapted for actuation by a handheld drill (not shown) by removal of hand crank 44, and coupling of the drill socket with the hub of the crank mechanism. Rotation of hand crank 44 causes crank mechanism 40 and chain 34 to result in simultaneous rotation of each gear 32, which gears are each connected to a corresponding jackscrew 28. Simultaneous rotation of the jackscrews 28 within each leg “A” results in the uniform telescopic extension and/or retraction of the upper leg members 22 relative to the lower leg members 24 thereby raising and/or lowering the attached upper assembly and the load supported thereby. The lower portion of each inner member 24 is equipped with a wheel 29 to allow the apparatus to roll.

A pair of upper cross members, referenced as 50 and 52 respectively, are slidably supported on opposing ends thereof by opposing sides of the upper structure so as to be capable of adjustment between the front and rear of the apparatus. Each upper cross member supports a pair of load-engaging members, referenced as “B”. Each load-engaging member “B” has a top portion that is supported by the transversely mounted upper cross members 50 and/or 52 in a manner that allows for the slidable adjustment of each load-engaging member “B” along the width of the apparatus. Each load-engaging member “B” is comprised of at least two telescopically adjustable members 42 and 44 to facilitate vertical adjustment thereof. Each load-engaging member includes a lower portion having a load-supporting, horizontally projecting flange 46.

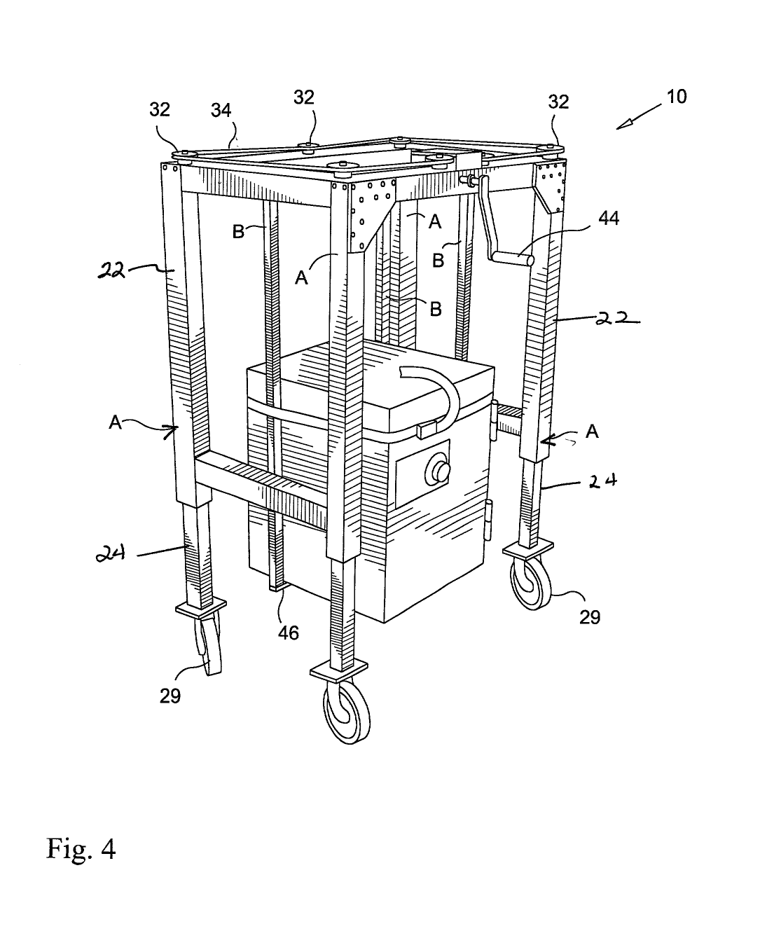

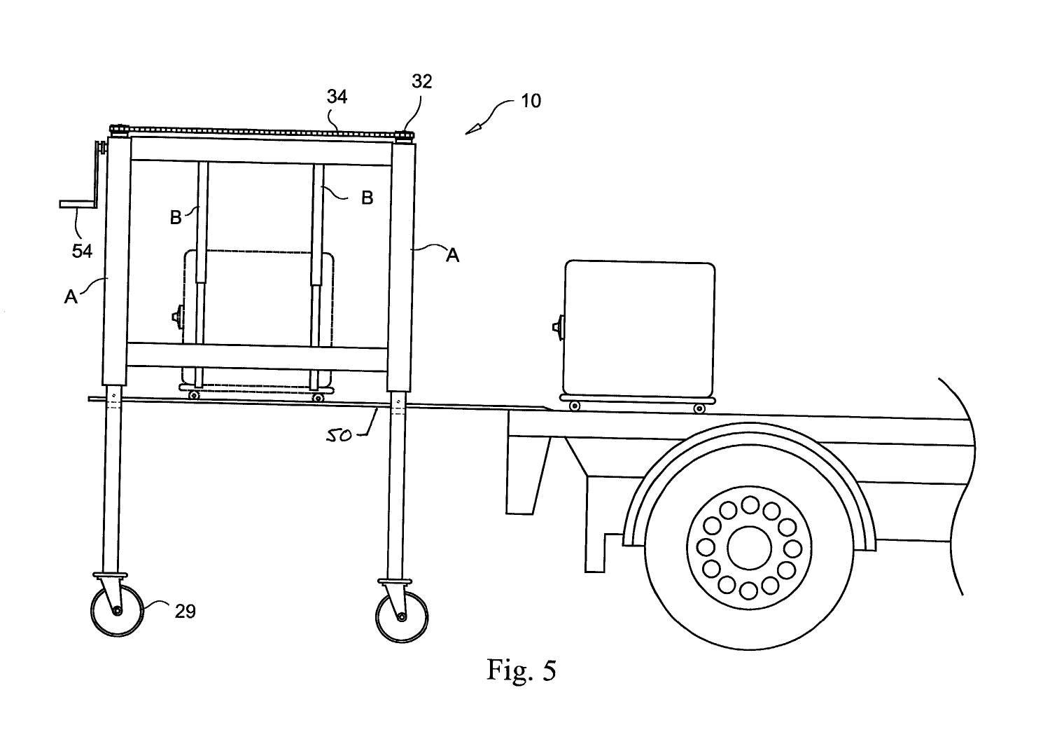

In use, apparatus 10 is transported to a site where a safe is to be transported. At the site, the load-engaging members “B” are adjusted as desired. The apparatus is wheeled into a position straddling the safe and the load-engaging members “B” are each slidably adjusted such that the load-supporting flanges 46 project under the bottom of the safe. Lifting of the safe is accomplished by actuation of the crank mechanism 40, either by manual rotation of hand crank 44 or by removal of the hand crank and powered rotation using a hand-drill (not shown). Actuation of the crank mechanism causes rotation of chain 34 which in turn causes simultaneous rotation of gears 32 and jackscrews 28 resulting in the telescopic extension on leg members 24 relative to leg members 22 thereby elevating the load as best depicted in FIGS. 4 and 5. Once elevated, the load is easily moved as the apparatus is supported by pivoting wheels 29.

The present invention may further cooperate with a transport vehicle, such as a van, having a cargo area incorporating a pair of deployable load-bearing rails, referenced as 50, having opposing ends that are adapted to connect to the apparatus 10 and the cargo area respectively, to facilitate loading and unloading of the safe between the transport vehicle cargo area and the apparatus 10. A vertically adjustable, horizontal beam 52 connected across the front portion thereof by adjustable connection to front legs “A”, provides a load bearing member for the rails. The rails are provided to form a deployable bridge between an elevated cargo bed of a truck or van and the horizontal beam member to facilitate loading and unloading of a safe. Use of such rails allows a single individual to deliver a safe from the supplier to the customer without the need for additional labor, or to retrieve the safe from the customer for service or repair.

The instant invention has been shown and described herein in what is considered to be the most practical and preferred embodiment. It is recognized, however, that departures may be made therefrom within the scope of the invention and that obvious modifications will occur to a person skilled in the art.

What we claim is:

1. An apparatus for lifting and transporting heavy objects, said apparatus comprising:
a plurality of vertically adjustable legs, each of said legs having an upper portion and a lower portion, said lower portion terminating in a wheel;
an upper frame assembly connected to said legs, said frame assembly including a plurality of downwardly extending load-bearing members, each of said load bearing members having a lower terminal end having a horizontally projecting flange;
means for selectively raising and lowering said upper frame assembly by vertical adjustment of said legs.

2. An apparatus according to claim 1, wherein vertical adjustment of said legs is accomplished by telescopic relative movement between said upper and lower portions.

3. An apparatus according to claim 2, wherein each of said legs include a longitudinally configured jackscrew disposed within an internally threaded member connected to said upper portion thereof, said jackscrew connected to said means for selectively raising and lowering said upper frame assembly.

4. An apparatus for lifting and transporting heavy objects, said apparatus comprising:
a plurality of vertically adjustable legs, each of said legs having an upper portion and a lower portion, said lower portion terminating in a wheel, said upper and lower portions being telescopically adjustable between fully extended and fully retracted positions;
an upper frame assembly connected to said legs and supported thereby, said frame assembly including a plurality of downwardly extending load-bearing members, each of said load bearing members having a lower terminal end having a horizontally projecting flange, said load bearing members being slidably adjustable along two generally perpendicular horizontal axes;
means for selectively raising and lowering said upper frame assembly by simultaneous vertical adjustment of said legs, said means for selectively raising and lowering including each leg having a longitudinally configured jackscrew disposed within an internally threaded member connected to said upper portion thereof, each of said jackscrews mechanically connected to said means for selectively raising and lowering said upper frame assembly, whereby actuation of said means for selectively raising and lowering said frame assembly causes simultaneous rotation of said jackscrews resulting in selective extension and retraction of legs.

5. An apparatus according to claim 4, further including a vertically adjustable horizontal beam connected on opposing ends thereof to said opposing front legs, said horizontal beam providing support for a pair of rails deployed between said beam and the cargo bed of a transport vehicle, said rails forming a bridge for moving a safe from said cargo bed into position relative to said apparatus for engagement by said plurality of load-bearing members.
